(19) United States
(12) Patent Application Publication
(10) Pub. No.: US 2026/0228332 A1
(43) Pub. Date: Aug. 6, 2026

(54) PROGRAM ANALYSIS DEVICE, PROGRAM ANALYSIS METHOD, AND NON-TRANSITORY COMPUTER READABLE MEDIUM

(71) Applicant: NEC Corporation, Tokyo (JP)

(72) Inventor: Yusuke SHIMADA, Tokyo (JP)

(73) Assignee: NEC Corporation, Tokyo (JP)

(21) Appl. No.: 19/148,034

(22) PCT Filed: Jan. 19, 2023
(86) PCT No.: PCT/JP2023/001483

§ 371 Date: Jul. 15, 2025

(51) Int. Cl. G06F 21/56; G06F 8/41

(52) U.S. Cl. CPC G06F 21/563; G06F 8/433

(57) ABSTRACT

A program analysis device (1001) includes: a flow length acquisition unit (1003) that acquires flow length information indicating a length of a processing flow to be analyzed that includes a sensitive operation defined by a predetermined start point and a predetermined end point in a program; and a score calculation unit (1004) that calculates a backdoor score indicating a possibility that the processing flow to be analyzed is a backdoor code based on the flow length information.

### TECHNICAL FIELD

The present disclosure relates to a program analysis device, a program analysis method, and a non-transitory computer readable medium.

### BACKGROUND ART

In recent years, infrastructure and company systems have become complicated. Therefore, the infrastructure and the company system are generally constructed not only by devices of a single company but also by procuring devices of various companies from the outside and combining these devices. As a measure against a risk related to the supply chain constructed in this way, the importance of a technology for detecting an illegal function in a program is increasing.

As an example of an illegal function in a program, many cases have been reported in which a backdoor is found in software (or firmware) or hardware procured from an external manufacturer. The “backdoor” referred to in the present specification can be defined as, for example, a function that is incorporated as a part of a program including a plurality of functions constituting software and is not notified to a user and is not desired by the user.

Therefore, a manufacturer who coordinates construction of an infrastructure or a company system needs to inspect whether a backdoor is included in a program constituting software procured from an external manufacturer. In order to inspect whether such an illegal function is incorporated in the program, a high-cost analysis in reverse engineering by an expert is necessary.

As a related art, PTL 1 provides a system for detecting a source of malicious activity in a computer system. The system disclosed in PTL 1 forms a graph representing a relationship between objects as edges based on information related to objects of the computer system, and determines a coefficient of degree of hazard of a partial graph. In addition, the system disclosed in PTL 1 identifies an object associated with at least one vertex of a partial graph as a source of malicious activity based on the sum of the coefficients of degree of hazard.

### CITATION LIST

### Patent Literature

PTL 1: JP 2020-109611 A

### SUMMARY OF INVENTION

### Technical Problem

It is assumed that a location where there is a possibility that a backdoor may exist is automatically extracted from the program by using the technique disclosed in PTL 1. In such a case, it is necessary to specify a processing flow including the location and perform detailed analysis. Furthermore, a person in charge of inspection needs to determine whether the backdoor actually exists according to the analysis result. In a case where there are a large number of locations, the burden on the person in charge of inspection increases, and thus it is desirable to specify a location where a check is to be preferentially performed among the plurality of locations. In the technique disclosed in PTL 1, such a problem is not mentioned.

In view of the above-described problems, an object of the present disclosure is to provide a program analysis device, a program analysis method, and a non-transitory computer readable medium capable of appropriately specifying a processing flow having a high possibility of including a backdoor from among a plurality of processing flows to be candidates.

### Solution to Problem

A program analysis device according to the present disclosure includes
flow length acquisition means for acquiring flow length information indicating a length of a processing flow to be analyzed including a sensitive operation defined by a predetermined start point and a predetermined end point in a program, and
score calculation means for calculating a backdoor score indicating a possibility that the processing flow to be analyzed is a backdoor code based on the flow length information.

A program analysis method according to the present disclosure includes
acquiring flow length information indicating a length of a processing flow to be analyzed including a sensitive operation defined by a predetermined start point and a predetermined end point in a program, and
calculating a backdoor score indicating a possibility that the processing flow to be analyzed is a backdoor code based on the flow length information.

A non-transitory computer readable medium according to the present disclosure is stored with a program for causing a computer to execute processes of
acquiring flow length information indicating a length of a processing flow to be analyzed including a sensitive operation defined by a predetermined start point and a predetermined end point in a program, and
calculating a backdoor score indicating a possibility that the processing flow to be analyzed is a backdoor code based on the flow length information.

### Advantageous Effects of Invention

According to the present disclosure, a program analysis device, a program analysis method, and a non-transitory computer readable medium capable of appropriately specifying a processing flow having a high possibility of including a backdoor from among a plurality of candidate processing flows can be provided.

### BRIEF DESCRIPTION OF DRAWINGS

FIG. 1 is a block diagram illustrating a configuration of a program analysis device according to a first example embodiment.

FIG. 2 is a flowchart illustrating a process performed by the program analysis device according to the first example embodiment.

FIG. 3 is a diagram illustrating an example of a backdoor included in control flows of software.

FIG. 4 is a diagram for explaining characteristics of the backdoor.

FIG. 5 is a diagram describing an outline of a process performed by a program analysis device according to a second example embodiment.

FIG. 6 is a diagram illustrating a sample code for explaining an approach method of the program analysis device according to the second example embodiment.

FIG. 7 is a block diagram illustrating a configuration of a program analysis device according to the second example embodiment.

FIG. 8 is a diagram illustrating an example of a sample code for explaining control dependency and data dependency according to the second example embodiment.

FIG. 9 is a diagram illustrating a sample code of a path traversal according to the second example embodiment.

FIG. 10 is a diagram illustrating a sample code of a hidden account according to the second example embodiment.

FIG. 11 is a diagram illustrating a sample code of the hidden account according to the second example embodiment.

FIG. 12 is a diagram illustrating a sample code for explaining a hierarchy of control dependency according to the second example embodiment.

FIG. 13 is a diagram illustrating a sample code for supplementary explanation regarding the hierarchy according to the second example embodiment.

FIG. 14 is a diagram schematically illustrating an example of a case where the control dependence relationship is hierarchized according to the second example embodiment.

FIG. 15 is a diagram illustrating a sample code for explaining a second calculation method according to the second example embodiment.

FIG. 16 is a diagram illustrating a sample code for explaining a third calculation method according to the second example embodiment.

FIG. 17 is a diagram illustrating a sample code for explaining a fourth calculation method according to the second example embodiment.

FIG. 18 is a diagram illustrating an output example of a backdoor score according to the second example embodiment.

FIG. 19 is a flowchart illustrating a process performed by the program analysis device according to the second example embodiment.

FIG. 20 is a block diagram illustrating a hardware configuration of a computer that achieves the program analysis device according to the example embodiment.

### EXAMPLE EMBODIMENT

Hereinafter, example embodiments of the present disclosure will be described in detail with reference to the drawings. In the drawings, the same or corresponding elements are denoted by the same reference signs. For clarity of description, redundant description will be omitted as necessary.

### First Example Embodiment

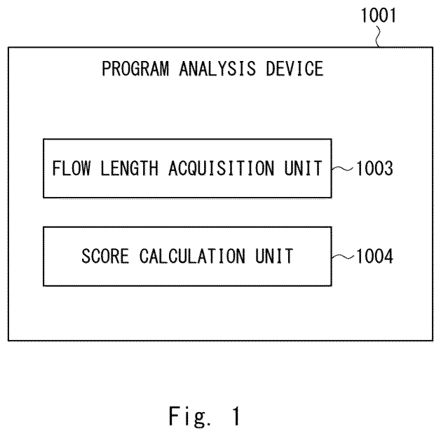

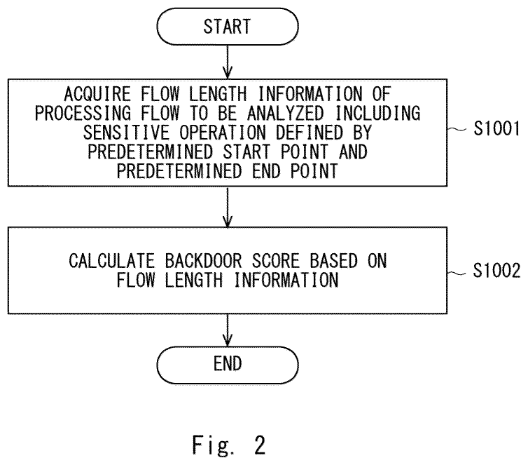

A first example embodiment will be described with reference to FIGS. 1 and 2. FIG. 1 is a block diagram illustrating a configuration of a program analysis device 1001 according to the present example embodiment. The program analysis device 1001 includes a flow length acquisition unit 1003 and a score calculation unit 1004.

The flow length acquisition unit 1003 acquires flow length information indicating the length of the processing flow to be analyzed including sensitive operation defined by a predetermined start point and a predetermined end point in the program.

The score calculation unit 1004 calculates a backdoor score indicating the possibility that the processing flow to be analyzed is a backdoor code based on the flow length information.

The program analysis device 1001 includes a processor, a memory, and a storage device as non-illustrated configurations. The storage device stores a computer program on which processing according to the present example embodiment is implemented. The processor causes the computer program to be read from the storage device into a memory, and is capable of executing the computer program. As a result, the processor achieves the functions of the flow length acquisition unit 1003 and the score calculation unit 1004.

Next, a process performed by the program analysis device 1001 will be described with reference to FIG. 2. FIG. 2 is a flowchart illustrating a process performed by the program analysis device 1001.

First, the flow length acquisition unit 1003 acquires flow length information of a processing flow to be analyzed including sensitive operation defined by a predetermined start point and a predetermined end point (S1001). Next, the score calculation unit 1004 calculates a backdoor score based on the flow length information (S1002).

With such a configuration, the program analysis device 1001 according to the present example embodiment can appropriately specify a processing flow having a high possibility of including a backdoor from among a plurality of processing flows to be candidates.

### Second Example Embodiment

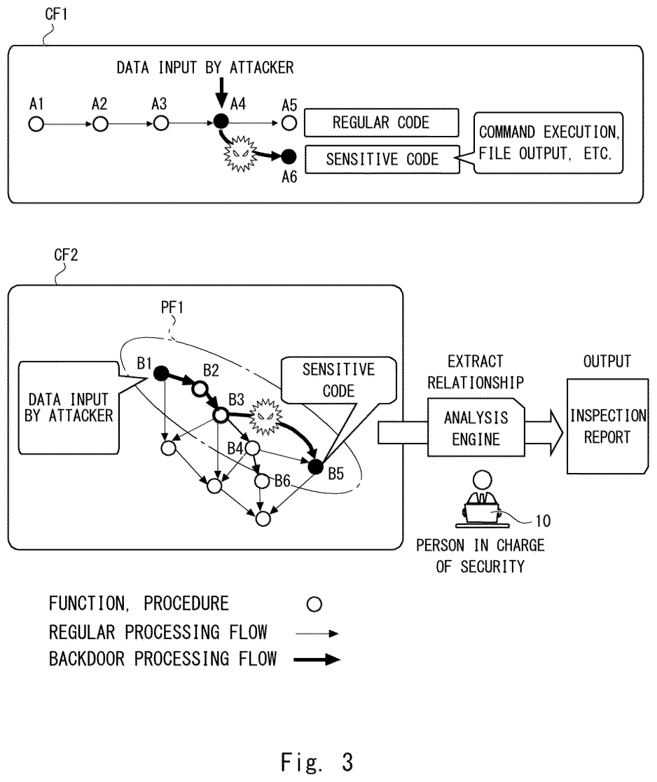

Next, a second example embodiment will be described with reference to FIGS. 3 to 19. The second example embodiment is a specific example of the above-described first example embodiment. Hereinafter, a program analysis device 10 according to the present example embodiment will be described. The program analysis device 10 is an information processing device capable of performing predetermined program analyzing process.

First, a program inspection technique will be described as a technique related to the program analysis device 10 according to the present example embodiment. In order to inspect whether the program to be analyzed includes an illegal function such as a backdoor, a code included in the program needs to be analyzed. As an analysis method, there are a method of performing analysis using a source code of a program to be analyzed and a method of performing analysis using a code included in a binary (hereinafter referred to as “target binary”) of the program to be analyzed.

In the present example embodiment, an analysis method using a code included in a target binary will be described as an example. By using such an analysis method, for example, a control flow and a data flow that depend on data input from the outside of the program can be extracted. As a result, the trigger of the backdoor can be automatically detected.

In addition, by using such an analysis method, for example, input/output to a register or a memory can be tracked, and a relationship between a code performing a sensitive operation and a trigger of a backdoor can be extracted in terms of security. As a result, a malicious data flow can be automatically detected.

The sensitive operation described herein is, for example, an operation that is considered to significantly affect a program or a system including an environment in which the program is executed in a case where the sensitive operation is illegally executed, and is an operation determined in advance by the user. The user is, for example, a requester who requests inspection of the program, an analyst who performs the inspection, a person in charge of security, or the like.

Here, an example in which a backdoor is installed in the program will be described with reference to FIG. 3. FIG. 3 is a diagram illustrating an example of a backdoor included in control flows CF1 and CF2 of software. In the figure, a circle indicates a function and a procedure. Hereinafter, a function or a procedure may be referred to as a “node”. In the figure, a thin arrow indicates a regular processing flow, and a thick arrow indicates a backdoor processing flow.

In the control flow CF1 illustrated in the upper part of FIG. 3, the nodes A1 to A5 are execution paths of the regular code. Normally, in a case where a regular user executes the control flow CF1, a process is executed through paths such as the nodes A1, A2, A3, A4, and A5.

However, in the example of the figure, a backdoor for proceeding the process from the node A4 to the node A6 is installed. An attacker can execute the process of the node A6 without passing through the regular node A5 by performing a predetermined input at the node A4. The attacker is, for example, a person who installed the backdoor in the program or a person related to that person.

The predetermined input performed by the attacker is a special input for achieving an illegal function. The predetermined input is, for example, an input for causing the program to execute a sensitive operation without going through a regular processing flow. The predetermined input may include, for example, input information known only by an attacker or a related person thereof. The input information is, for example, information regarding a hidden function not described in a specification or the like, information for avoiding an authentication function, a predetermined command character string, or the like. Since these are examples, the input information may include various input data for achieving the illegal function.

The node A6 includes a code for performing a sensitive operation (e.g., command execution, file output, etc.) on a system or the like. The attacker forms a processing flow different from the regular processing flow and attempts to execute an illegal operation by installing the backdoor. For example, the attacker may install such a backdoor in the program as a hidden function.

In the lower part of FIG. 3, an example of the control flow CF2 including a branch and a rough flow of a process performed by the program analysis device 10 according to the present example embodiment are illustrated. In this example, in the control flow CF2, a backdoor for executing an illegal process on the path of the nodes B1, B2, B3, and B5 is installed. For example, the attacker performs a predetermined data input in the node B1 to cause the node B1 to execute the process in the path of the nodes B1, B2, B3, and B5. The node B5 includes a code for performing a sensitive operation on a system or the like.

Here, the node B5 is a node that can be passed through in a regular processing flow. For example, assume that the node B4 is an authentication function for authenticating as a regular user. In the regular processing flow, the authentication function is executed in the node B4, where the process of the node B5 is executed in a case where the authentication is successful, and the process of the node B6 is executed in a case where the authentication is unsuccessful. By doing so, in the regular processing flow, the sensitive operation can be executed only if the user succeeds in authentication, and the sensitive operation can be prevented from being executed if the authentication fails.

However, in the control flow CF2, the attacker forms a flow for avoiding the authentication function by installing a backdoor that does not pass through the node B4. As a result, the attacker can execute a sensitive operation while avoiding the authentication function.

The program analysis device 10 according to the present example embodiment performs predetermined analysis focusing on characteristics of a backdoor to be described later. Specifically, the program analysis device 10 performs an analysis on the processing flow to be analyzed including a predetermined start point and a predetermined end point. In addition, the program analysis device 10 calculates a backdoor score corresponding to the processing flow to be analyzed by using the information obtained from the analysis result. In the example of the figure, the predetermined start point is the node B1 where data input by the attacker is performed. The predetermined end point is the node B5 including a sensitive code. The sensitive code may include a function that may execute a sensitive operation. Hereinafter, description may be made with a function that can perform a sensitive operation being referred to as a “sensitive function”.

Examples of the sensitive function include, for example, a system call, a predetermined library function, and a predetermined application programming interface (API), or a function related to an operation requiring a predetermined authority. Specifically, the sensitive function is a sink function for outputting information inside the system to the outside, or the like.

For example, the program analysis device 10 analyzes a processing flow PF1 having the node B1 as a start point and the node B5 as an end point. For example, the program analysis device 10 performs control flow analysis and data flow analysis on the processing flow PF1 to extract a relationship between the external input performed by the attacker and the sensitive operation. The external input is an input performed on the program to be analyzed from the outside of the program. The external input may include a special input for achieving an illegal function.

The program analysis device 10 outputs the result of the backdoor inspection as an inspection report based on the analysis result. The inspection report indicates information relating to the backdoor, such as, for example, “start shell program by external hidden password input” and “output password information to log file by external hidden command”. In addition, the program analysis device 10 outputs the calculated backdoor score to the inspection report. For example, the program analysis device 10 outputs information relating to the backdoor score such as “The backdoor score of processing Flow 1 is 120”.

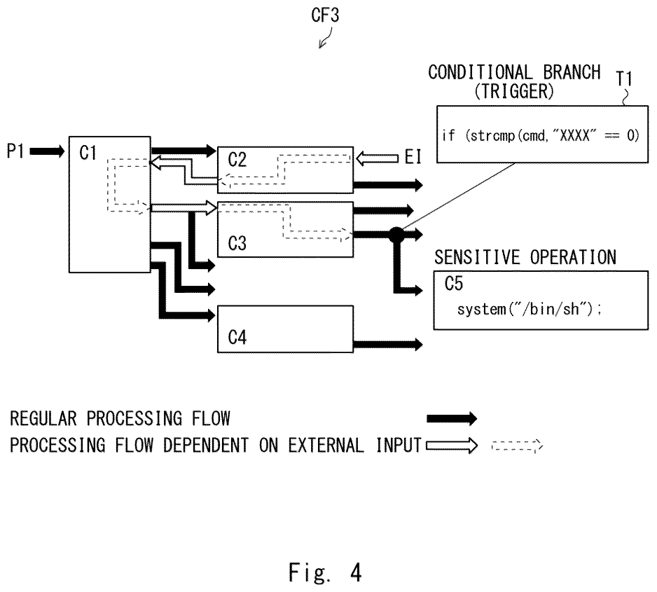

Next, characteristics of the backdoor will be described with reference to FIG. 4. FIG. 4 is a diagram for explaining characteristics of the backdoor. The control flow CF3 illustrated in the figure includes nodes C1 to C5. The control flow CF3 is a control flow that starts a process from an entry point P1 and enables execution of the process of each node according to a branch.

In the figure, a solid black arrow indicates a regular processing flow. Furthermore, a solid white arrow and a broken white arrow indicate a processing flow that depend on an external input EI which is information input from the outside. In the control flow CF3, the node C5 includes a code for performing a sensitive operation. The processing flow including the backdoor has common features as described below.

A first feature is that input information (trigger) that only an attacker knows exists. The input information that only the attacker knows is, for example, hidden authentication information, a predetermined command character string, or the like. In the figure, a conditional branch T1 is illustrated as an example of the trigger.

A second feature is to pass through an execution path that satisfies a specific condition. The execution path satisfying a specific condition is a non-regular execution path. The non-regular execution path may partially include a regular execution path.

Input information of an illegal external input by an attacker may be used to satisfy a specific condition. For example, it is conceivable to compare an illegal external input by an attacker with predetermined information and branch a path according to a comparison result. In a case where an illegal external input is accepted, a subsequent processing flow can be executed via a non-regular execution path. In the example of the figure, a non-regular execution path is formed by the existence of the external input EI.

A third feature is to finally perform a sensitive operation on the system by using the non-regular path described above. The sensitive operation is, for example, start of a shell, illegal communication, writing of confidential data to a file, or the like. In the example of the figure, a sensitive operation is executed at the node C5.

### (Outline of Process Performed by Program Analysis Device 10)

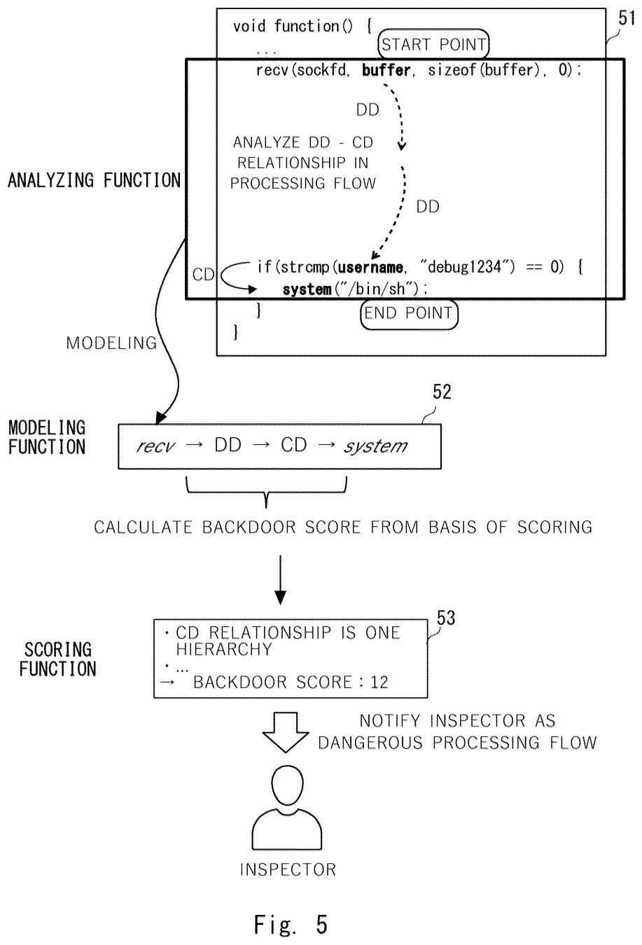

Here, an outline of a process performed by the program analysis device 10 according to the present example embodiment will be described with reference to FIG. 5. FIG. 5 is a diagram describing an outline of a process performed by the program analysis device 10. As illustrated in the figure, the program analysis device 10 has an analyzing function, a modeling function, and a scoring function.

The analyzing function is a function of analyzing the processing flow to be analyzed. As indicated by a sample code 51 in the figure, the processing flow to be analyzed is defined by a predetermined start point and a predetermined end point. DD and CD in the figure are information indicating a relationship between codes included in the processing flow to be analyzed. DD indicates data dependency between variables (or between instructions having variables as input/output). In addition, CD indicates control dependency of an instruction and conditional branching. The program analysis device 10 extracts data dependency and control dependency in the processing flow to be analyzed. Details of each will be described later.

The modeling function is a function of generating construction information indicating how the processing flow to be analyzed is constructed based on the analysis result of the processing flow to be analyzed. For example, the program analysis device 10 generates a model 52 for calculating the backdoor score as illustrated in “recv→DD→CD→system” in the figure as the construction information. The construction information is not limited to a specific model or format. The program analysis device 10 can generate the construction information in an arbitrary mode.

The scoring function is a function of calculating a backdoor score based on the construction information. The program analysis device 10 calculates the backdoor score based on, for example, the model 52. The program analysis device 10 notifies the inspector of the report 53 including the result of scoring. As a result, the program analysis device 10 can notify the inspector of a dangerous processing flow.

In the present example embodiment, the program analysis device 10 including all the above-described analyzing function, modeling function, and scoring function will be described, but the program analysis device 10 may have a configuration including a part of these functions. For example, the program analysis device 10 may be configured to acquire an analysis result and construction information from another device or the like having an analyzing function and a modeling function, and calculate a backdoor score based on the acquired information.

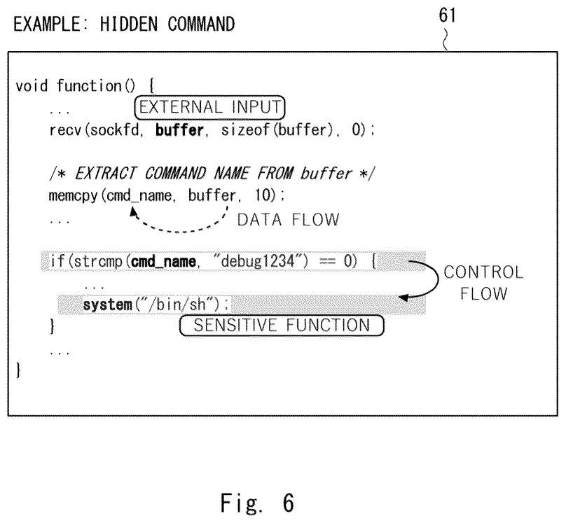

Here, an approach method for the program analysis device 10 according to the present example embodiment to perform backdoor detection will be described with reference to FIG. 6. FIG. 6 is a diagram illustrating a sample code 61 for explaining an approach method of the program analysis device 10 according to the present example embodiment. The sample code 61 is an example of a hidden command in the program.

In order to detect the backdoor, a relationship between an external input to the program and a sensitive operation included in the program needs to be analyzed. Therefore, in the present example embodiment, the following two program analyzing techniques are used.

The first analyzing technique is a control flow analysis. The control flow analysis is a technique for analyzing the control dependency (hereinafter sometimes referred to as “CD”) of an instruction and conditional branches. The analyzing unit 11 extracts the control dependency included in the processing flow to be analyzed by performing control flow analysis on the processing flow to be analyzed.

The second analyzing technique is a data flow analysis. The data flow analysis is a technique for analyzing the data dependency (hereinafter, may be referred to as “DD”) between variables (or between instructions having variables as input/output). The analyzing unit 11 extracts data dependency included in the processing flow to be analyzed by performing data flow analysis on the processing flow to be analyzed.

### (Configuration of Program Analysis Device 10)

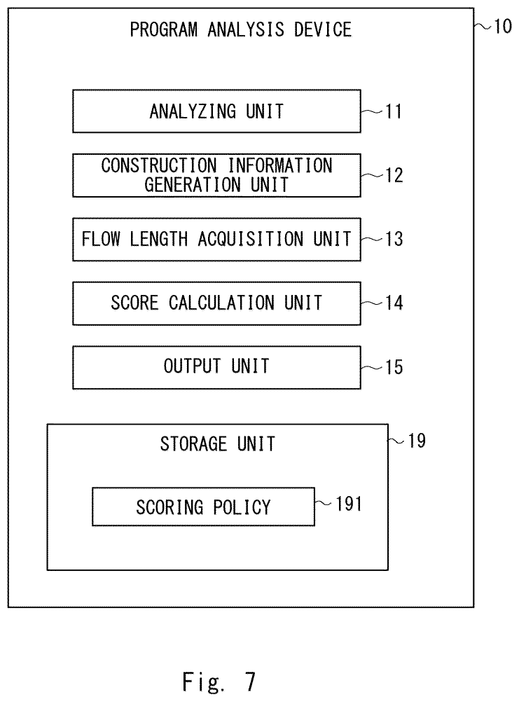

Next, a configuration of the program analysis device 10 according to the present example embodiment will be described with reference to FIG. 7. FIG. 7 is a block diagram illustrating a configuration of the program analysis device 10. The program analysis device 10 is an example of the program analysis device 1001 described above.

As illustrated in the figure, the program analysis device 10 includes an analyzing unit 11, a construction information generation unit 12, a flow length acquisition unit 13, a score calculation unit 14, an output unit 15, and a storage unit 19.

The analyzing unit 11 extracts a predetermined start point and end point from the program, specifies a processing flow to be analyzed defined by the start point and the end point, and analyzes the processing flow to be analyzed to acquire the relationship information. Here, the relationship information may include at least one of the control dependency and the data dependency described above.

A start point of the processing flow to be analyzed is a function for acquiring an external input. The function for acquiring an external input is, for example, a recv function for acquiring information from the outside of the system via a network, and these functions are collectively referred to as an src (source) function.

In addition, the end point of the processing flow to be analyzed may be a sensitive function that can perform a sensitive operation on a system including a program in a case where it is illegally executed. The sensitive function is, for example, a write function for outputting information inside the system to the outside, and these are collectively referred to as a sink function.

For example, it is assumed that the start point is the src function and the end point is the sink function. In this case, the analyzing unit 11 specifies the processing flow from the src function to the sink function as the processing flow to be analyzed. The analyzing unit 11 analyzes the processing flow to be analyzed and extracts control dependency and data dependency in the flow.

For example, the analyzing unit 11 may extract a function calling location indicating a location where the sensitive function is called in the program, and specify the calling location as an end point. The analyzing unit 11 may measure the number of executions or the execution frequency of a predetermined function at the time of normal execution of the program for each function calling location, and narrow down the analysis target location to be the target of the processing flow analysis based on the number of executions or the execution frequency.

The time of normal execution indicates a timing at which the program is executed in a normal execution environment. The time of normal execution time may be, for example, a timing at which the program to be analyzed is actually operated in a service, business, or the like, a timing at which an operation test of the program is performed using a test environment, or the like. The analyzing unit 11 can specify the extracted analysis target location as a start point or an end point. As a result, the analyzing unit 11 specifies the processing flow to be analyzed.

The analyzing unit 11 performs, as analysis, at least one of control flow analysis for obtaining control flow information indicating a control dependency among a plurality of codes in the processing flow to be analyzed and data flow analysis for obtaining data flow information indicating a data dependency among a plurality of codes. As a result, the analyzing unit 11 acquires the relationship information. Each of the plurality of codes is for executing a function or a procedure.

For example, the analyzing unit 11 acquires relationship information indicating the relationship between the code of the start point and the code of the end point of the processing flow to be analyzed. The analyzing unit 11 may acquire the relationship information using a code that is neither the start point nor the end point. For example, the analyzing unit 11 acquires the relationship information by using the first code and the second code existing between the start point and the end point.

For example, the first code is a code existing at a location after the start point and before the second code. Furthermore, for example, the second code is a code existing at a location after the first code and before the end point. In this case, the analyzing unit 11 performs, as analysis, at least one of control flow analysis for obtaining control flow information indicating a control dependency between the first code and the second code and data flow analysis for obtaining data flow information indicating a data dependency between the first code and the second code. As a result, the analyzing unit 11 acquires the relationship information indicating the relationship between the first code and the second code.

In the above description, an example has been described in which both the first and second codes are located between the start point and the end point, but either one of the first and second codes may correspond to the start point or the end point of the processing flow to be analyzed. Furthermore, in the above description, an example has been described in which the analyzing unit 11 acquires the relationship information indicating the relationship between two codes, but the analyzing unit 11 may acquire the relationship information indicating the relationship between three or more codes.

Here, the control dependency will be specifically described. The analyzing unit 11 can analyze the control dependence relationship by acquiring a conditional branch controlling arrival in the control flow with respect to a certain instruction. As a result, the analyzing unit 11 acquires the control flow information indicating the control dependency between the codes.

For example, assume that there are two codes indicated by the following codes S1 and S2.
S1: if (A) then

$$B = C * D \qquad S2$$

In this case, S2 depends on S1. Therefore, in this case, it can be said that there is control dependency between S1 and S2.

Here, the data dependency will be specifically described. The analyzing unit 11 can analyze the data dependence relationship by tracking the input/output of data. As a result, the analyzing unit 11 acquires the data flow information indicating the data dependency between the codes. The analyzing unit 11 may acquire information analyzed by another analysis framework.

For example, assume that there are two codes indicated by the following codes S3 and S4.

$$S 3 A = B * C \qquad S3$$

$$S4D = {A}^{*} E + 1 \qquad S4$$

In this case, S4 depends on S3. Therefore, in this case, it can be said that there is data dependency between S3 and S4.

The analyzing unit 11 performs, for example, data flow analysis and control flow analysis by forward analysis from a start point in the processing flow to be analyzed, and continuously tracks data dependency and control dependency to an end point of the analysis. As a result of the analysis, the analyzing unit 11 extracts how the start point to the end point of the analysis are related in the control dependency and the data dependency.

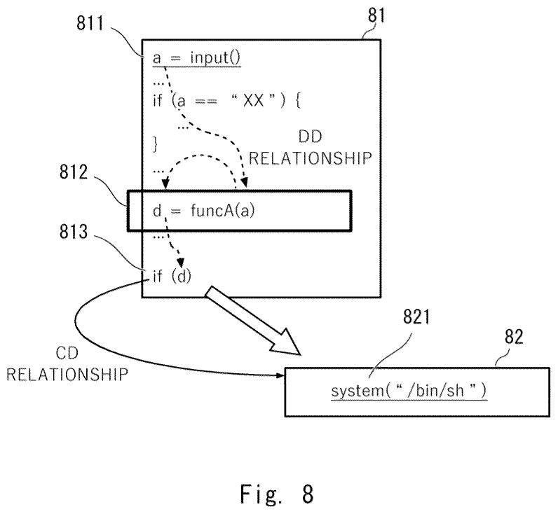

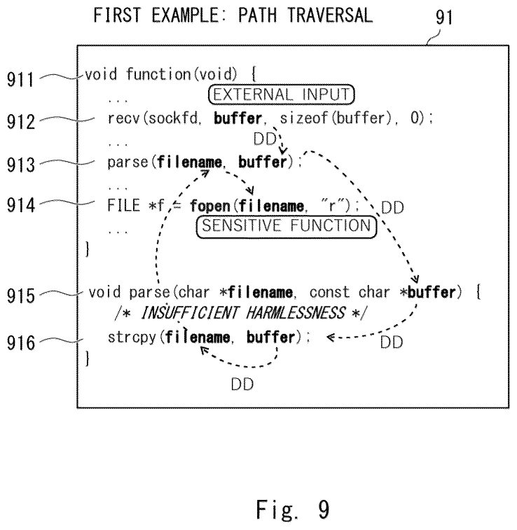

FIG. 8 is a diagram illustrating an example of a sample code for explaining the control dependency and the data dependency. A solid line arrow in the figure indicates control dependency, and a broken line arrow indicates data dependency. The same applies to FIGS. 9 to 11 described later.

In a code 811 included in a code block 81, an input function which is the src function is called. In addition, in a code 821 included in a code block 82, a system function which is the sink function is called.

In the code 811, an external input is accepted. In the code 812, a function funcA is called and a value is substituted into the variable d. Therefore, the codes 811 and 812 are in a data dependence relationship. In addition, in the code 812, the value of d depends on funcA(a). Therefore, d and funcA(a) are in a data dependence relationship.

Furthermore, in a code 813, conditional branching is performed using the variable d. Therefore, the control of calling of the system function in the code 821 depends on the value of the variable d. Thus, the code 821 and the code 813 are in a control dependence relationship.

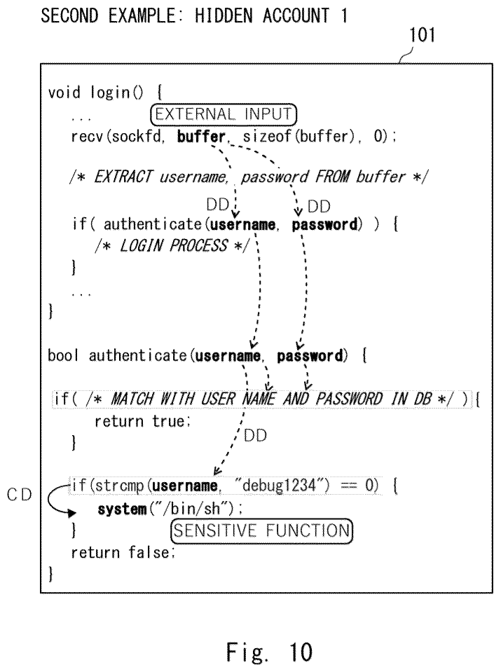

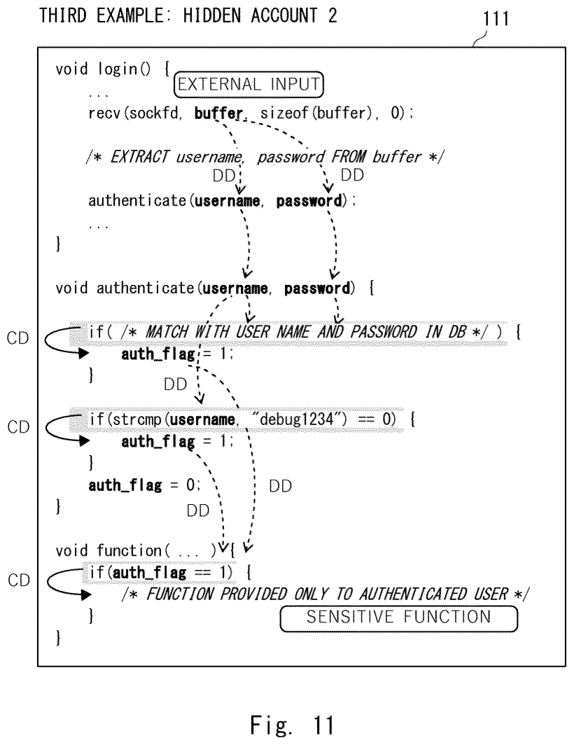

Next, an example of an illegal function detected by the analyzing unit 11 will be described with reference to FIGS. 9 to 11. FIG. 9 is a diagram illustrating a sample code of path traversal. FIGS. 10 and 11 are diagrams illustrating sample codes of a hidden account.

FIG. 9 is a diagram illustrating a sample code 91 according to an example of the pass traversal. The sample code 91 has codes 911 to 916. The recv function indicated in the code 912 is an example of the src function. In addition, a fopen function illustrated in the code 914 is an example of the sink function.

As illustrated in the figure, the sample code 91 includes a plurality of data dependence relationships. For example, the sample code 91 includes data dependence relationships between codes 912 and 913, between codes 913 and 914, between codes 913 and 915, between codes 915 and 916, and between arguments of the strcpy function in code 916.

As described above, the processing flow to be analyzed may include only the data dependence relationship without including the control dependence relationship. Furthermore, although not illustrated, there is a case where the processing flow to be analyzed does not include the data dependence relationship but includes only the control dependence relationship.

FIGS. 10 and 11 are diagrams illustrating examples of a hidden account. FIG. 10 is a diagram illustrating a sample code 101 as a first example of a hidden account. The sample code 101 includes one control dependence relationship. Furthermore, FIG. 11 is a diagram illustrating a sample code 111 as a second example of a hidden account. The sample code 111 includes a plurality of control dependence relationships.

Returning to FIG. 7, the description will be continued. The construction information generation unit 12 acquires, from the analyzing unit 11, relationship information indicating a relationship among a plurality of codes included in the processing flow to be analyzed. The construction information generation unit 12 generates construction information indicating how the processing flow to be analyzed is constructed based on the relationship information. The construction information generation unit 12 generates, for example, model information indicating the control dependency and the data dependency included in the processing flow to be analyzed, such as the model 52 described above, as the construction information. The construction information generation unit 12 may perform modeling using artificial intelligence (AI) or the like to generate construction information.

Here, a relationship between an external input and a sensitive operation will be described. The processing flow having illegal function started by the external input is constructed by data dependency (DD) and control dependency (CD) between the external input (EI) and the sensitive operation (SO).

The following (C1) to (C4) are examples of the construction information.
(C1) Execute the sensitive operation (SO) by branching having a propagation result of the external input (EI) as a condition (control dependency)

$$EI -> DD -> CD -> SO$$

(C2) Execute the sensitive operation (SO) using a propagation result of the external input (EI) as an execution time argument (data dependency)

$$EI -> DD -> SO\_arg$$

(C3) Set a variable (authentication variable) indicating an authentication state by a conditional branch according to the propagation result of the external input (EI). Thereafter, execute sensitive operation (SO) by branching having the authentication variable as a condition

$$EI -> DD -> CD -> auth\_flag -> ( DD -> ) CD -> SO$$

(C4) Set a value (fixed value) to the argument variable of the sensitive operation (SO) by the conditional branch according to the propagation result of the external input (EI). Thereafter, execute the sensitive operation (SO) with the argument variable as an argument (data dependence relationship between the argument variable and the sensitive operation)

$$EI -> DD -> CD -> arg\_var -> ( DD -> ) SO\_arg$$

The example described above is an example, and hence the construction information can be appropriately combined. Zero or more control dependencies and data dependencies may exist in the processing flow to be analyzed. A plurality of control dependencies and a plurality of data dependencies may exist.

The following findings can be obtained based on the construction information as described above.

### (First Finding)

The relationship between the external input (EI) and the sensitive operation (SO) can be expressed by one of the following two types of regular expressions by using data dependency (DD) and control dependency (CD). The symbol “*” represents 0 or more repetitions of the symbol indicated immediately before. For example, “(CD|DD)*” indicates that CD or DD is repeated zero or more times.
1. A case where the external input and the sensitive operation are not in the “direct” data dependence relationship as the control dependency is always interposed

$$( EI , SOtype 1 ) = ( CD \vert DD ) * CD ( CD \vert DD ) * \qquad Relation$$

2. A case where the external input and the sensitive operation are in the “direct” data dependence relationship as the control dependency is not interposed

$$( EI , SOtype 2 ) = ( DD ) * DD \qquad Relation$$

### (Second Finding)

The depth of the control dependence relationship is assumed to be equal to or less than a predetermined value. For example, the depth of the control dependence relationship is assumed to be about double or triple at most. For example, the sample code 111 illustrated in FIG. 11 described above is an example in which the depth of the control dependence relationship is double. An even deeper control dependence relationship increases complexity for starting an illegal function by an external input, and thus is less conceivable from the viewpoint of implementing an attack. Therefore, a case where the depth of the control dependence relationship is equal to or more than a certain value may be excluded from the target of the backdoor score calculation in the score calculation unit 14 to be described later. Details of a method of calculating the backdoor score will be described later.

### (Hierarchy of Control Dependency)

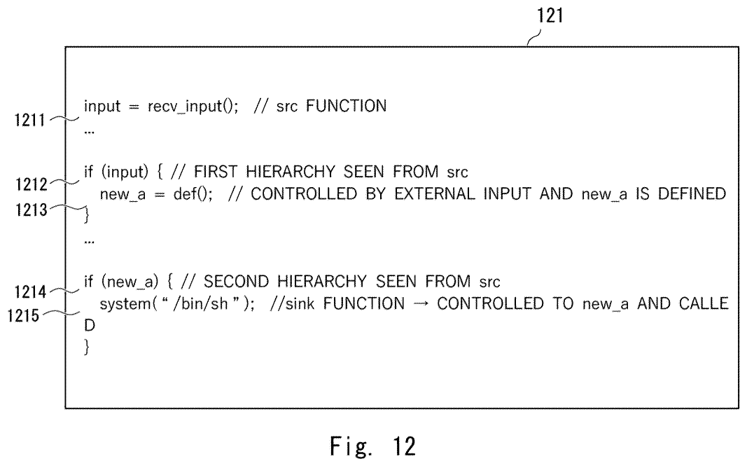

Here, generation of the construction information in the construction information generation unit 12 will be specifically described with reference to FIG. 12. FIG. 12 is a diagram illustrating a sample code 121 for explaining the hierarchy of control dependency. The sample code 121 has codes 1211 to 1215.

The hierarchy indicates the complexity of the control relationship among the plurality of nodes. The larger the hierarchy, the more complex the control dependency between the nodes. Therefore, in a case where a node in a control dependence relationship includes a sensitive operation, it is assumed that the sensitive operation is less likely to be triggered the larger the hierarchy.

As illustrated in the figure, code 1211 is the src function. In the code 1211, a variable “input” is defined according to the external input.

The control dependence relationship exists between the conditional branch in the code 1212 and the operation of the code 1213 controlled to the conditional branch of the code 1212. There is one control dependence relationship between the codes 1212 and 1213. As described above, in a case where there is one control dependency between two codes, the two codes are in a control dependence relationship of one hierarchy.

Furthermore, in the code 1213, a variable “new_a” is newly defined. In addition, in the code 1214, a conditional branch different from the code 1212 is executed. As a result, the code 1214 controls the operation of the code 1215.

In this case, a control dependence relationship different from the control dependence relationship described above exists between the operation of the code 1214 and the operation of the code 1215.

In the conditional branch of the code 1214, the output of the code 1213 is set as a condition. That is, the conditional branch of the code 1214 is controlled by an external input (“input”), controlled to a defined value (“new_a”) and called. In such a case, the code 1214 has a control dependence relationship in which one hierarchy is further added from the code 1212. That is, the code 1214 has a control dependence relationship of two hierarchies with the code 1211.

The construction information indicating the structure of the sample code 121 can be expressed as follows.

$$input -> CD -> new\_a -> CD -> system ( )$$

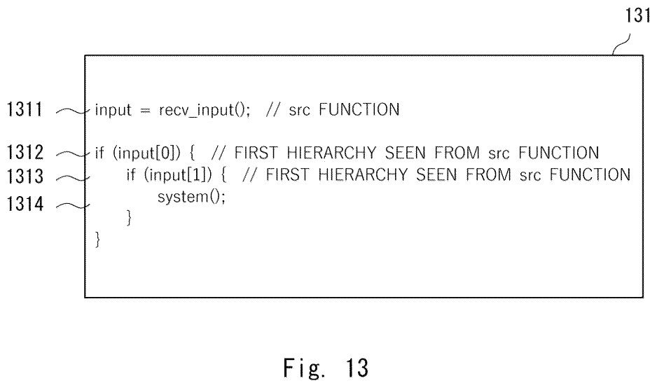

A supplementary description will be given for the hierarchy of the control dependence relationship described above with reference to FIG. 13. FIG. 13 is a diagram illustrating a sample code 131 for supplementary explanation regarding the hierarchy. The sample code 131 has codes 1311 to 1314.

The sample code 131 has two conditional branches for controlling the system function call. The conditional branches are codes 1312 and 1313. In this case, there is not a control dependence relationship of two hierarchies in a case where the src function illustrated in the code 1311 is viewed, but there are two conditional branches corresponding to the first hierarchy in a case where the src function is viewed. This is because the condition variable of the second conditional branch (code 1313) is not defined by the operation controlled by the first conditional branch (code 1312).

The construction information indicating the structure of the sample code 131 can be expressed as follows.

$$input [ 0 ] -> CD -> system ( )$$

$$input [ 2 ] -> CD -> system ( )$$

As described above, the control dependence relationship between the code 1311 and the code 1312 is one hierarchy. Similarly, the control dependence relationship between the code 1311 and the code 1313 is also one hierarchy.

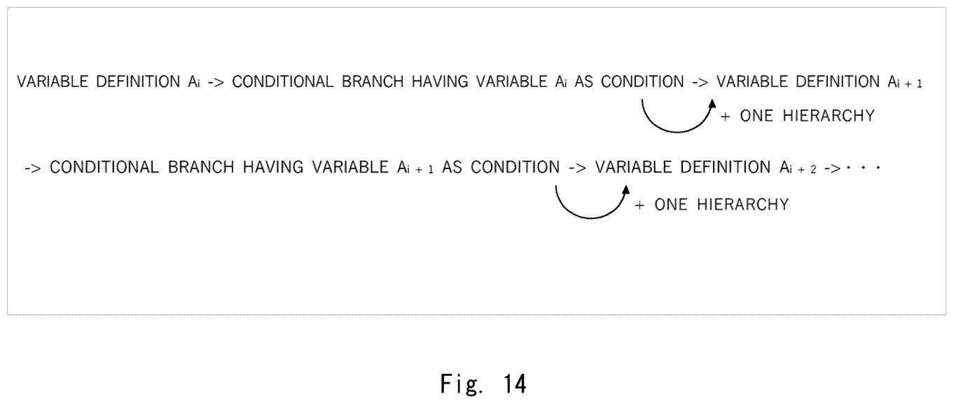

FIG. 14 is a diagram schematically illustrating an example of a case where the control dependence relationship is hierarchized. As illustrated in the figure, assume that there is construction information expressed as follows.
Variable definition Aᵢ->conditional branch with variable Aᵢ as condition->variable definition Aᵢ₊₁->conditional branch with variable Aᵢ₊₁ as condition->variable definition Aᵢ₊₂ . . . .

In the above case, in a case where “variable definition Aᵢ₊₁” is performed after “conditional branch with variable Aᵢ as condition”, the hierarchy is incremented by one. Furthermore, in a case where “variable definition Aᵢ₊₂” is further performed after “conditional branch with variable Aᵢ₊₁ as condition”, the hierarchy is further increased by one.

Returning to FIG. 7, the description will be continued. The flow length acquisition unit 13 is an example of the flow length acquisition unit 1003 described above. The flow length acquisition unit 13 acquires flow length information indicating the length of the processing flow to be analyzed including sensitive operation defined by a predetermined start point and a predetermined end point in the program.

The flow length information is information related to easiness of triggering of the backdoor. The flow length information is used for calculating a backdoor score in the score calculation unit 14 described later. The flow length information may include, for example, information indicating the number of function nodes existing between the two codes. Furthermore, the flow length information can include information related to the number of hierarchies described above. In the present example embodiment, the flow length acquisition unit 13 acquires the flow length information based on the construction information generated by the construction information generation unit 12.

The flow length information is, for example, information indicating the complexity of the control dependence relationship from the start point to the end point. Furthermore, the flow length information may be information indicating the length of the processing flow from the start point to the backdoor trigger candidate. The backdoor trigger candidate indicates a process that can be a trigger of the backdoor. The backdoor trigger candidate is, for example, a code that performs conditional branching. Furthermore, the flow length information may be information indicating the length of the processing flow from the backdoor trigger candidate to the end point.

The score calculation unit 14 is an example of the score calculation unit 1004 described above. The score calculation unit 14 calculates a backdoor score based on the flow length information acquired by the flow length acquisition unit 13. The backdoor score is a score indicating the possibility that the processing flow to be analyzed is a backdoor code. The backdoor score is, for example, a numerical value indicating the degree of possibility that the processing flow to be analyzed is a backdoor code. The backdoor score may be expressed using the grade of malignancy or the like of the processing flow to be analyzed.

For example, the score calculation unit 14 calculates the backdoor score according to the feature amount of the processing flow to be analyzed. The feature amount of the processing flow to be analyzed is information indicating the feature of the processing flow to be analyzed. The feature amount may include the number of hierarchies indicated by the control dependency included in the processing flow to be analyzed. Furthermore, the feature amount can include, for example, the number of function nodes included in the processing flow to be analyzed.

The score calculation unit 14 gives the calculated backdoor score to the processing flow to be analyzed. In a case where there are a plurality of processing flows to be analyzed, the score calculation unit 14 calculates a backdoor score for each of the plurality of processing flows to be analyzed, and gives the calculated backdoor score to the respective processing flow to be analyzed. The score calculation unit 14 may store the processing flow to be analyzed and the backdoor score in the storage unit 19 in association with each other.

The score calculation unit 14 can calculate the backdoor score using a predetermined scoring policy based on the flow length information. The scoring policy is information serving as a reference for calculating the backdoor score. In the present example embodiment, it is assumed that a scoring policy 191 is stored in the storage unit 19 in advance. The score calculation unit 14 calculates a backdoor score with reference to the scoring policy 191.

The score calculation unit 14 can select a calculation method from a plurality of calculation methods. The following is an example of a method of calculating the backdoor score. Each calculation method will be described. The score calculation unit 14 can appropriately select a calculation method according to the viewpoint of the inspector.

### (First Calculation Method)

In a case where the number of hierarchies indicated by the control dependency included in the processing flow to be analyzed is equal to or less than n (n is a natural number equal to or more than two), the score calculation unit 14 calculates the backdoor score such that the backdoor score is higher than that in a case where the number of hierarchies is larger than n. n is assumed to be, for example, two. n can be set in advance by an inspector or the like. In addition, n can be appropriately changed. The score calculation unit 14 may calculate the same backdoor score in the case of n=1 and the case of n=2.

For example, assumed that n=2. In a case where the number of hierarchies is one or two, the score calculation unit 14 calculates a backdoor score higher than that in a case where the number of hierarchies is three or more. For example, in a case where the number of hierarchies is one or two, the score calculation unit 14 calculates ten as the backdoor score. On the other hand, in a case where the number of hierarchies is three or more, 0 is calculated as the backdoor score.

In the example described above, the score calculation unit 14 may calculate the backdoor score such that the backdoor score increases as the number of hierarchies decreases. In this case, in a case where the number of hierarchies is one, the score calculation unit 14 calculates a backdoor score higher than that in a case where the number of hierarchies is two.

### (Second Calculation Method)

The score calculation unit 14 may calculate the backdoor score based on the number of function nodes between the first code indicating the external input and the second code indicating the control dependency of the first hierarchy from the first code.

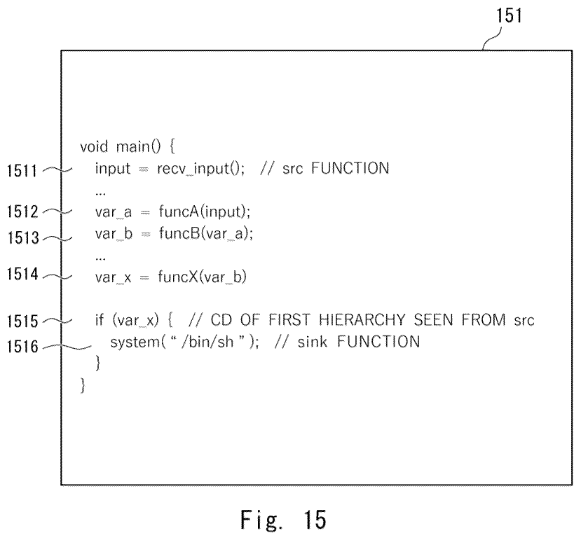

FIG. 15 is a diagram illustrating a sample code 151 for explaining a second calculation method. In the figure, the start point is the external input (src function) indicated in a code 1511. The score calculation unit 14 calculates the backdoor score based on the length of the function node from the external input to a code 1515 indicating the control dependency of the first hierarchy. The length of the function node corresponds to the number of function nodes through which the external input passes. The length of the function node indicates the closeness of the distance from the external input to the trigger. The conditional branch of the code 1515 is a function that triggers the backdoor.

As the number of function nodes passed through increases, the distance from the src function to the point indicating the control dependency of the first hierarchy increases, so that it is assumed that the sensitive function is less likely to be triggered. By using this, the score calculation unit 14 can calculate the backdoor score to be smaller as the distance becomes larger.

In this calculation method, in a case where x is the number of function nodes, the backdoor score fa (x) is expressed by the following Formula (1).

$$fa ( x ) = 1 / x \qquad ( 1 )$$

In the example illustrated in the figure, the external input passes through three functions from the src function of the code 1511 to “if (var_x)” of the code 1515 which is a point indicating the control dependency of the first hierarchy. Therefore, in this example, the score calculation unit 14 calculates the backdoor score as ⅓.

As a result, the score calculation unit 14 can calculate the backdoor score according to the number of function nodes through which the external input passes from the src function to the point indicating the control dependency to the first hierarchy.

### (Third Calculation Method)

The score calculation unit 14 may calculate the backdoor score based on the number of function nodes between a first code indicating a sensitive operation and a second code having a control dependency on the first code and located at a position closest to the first code.

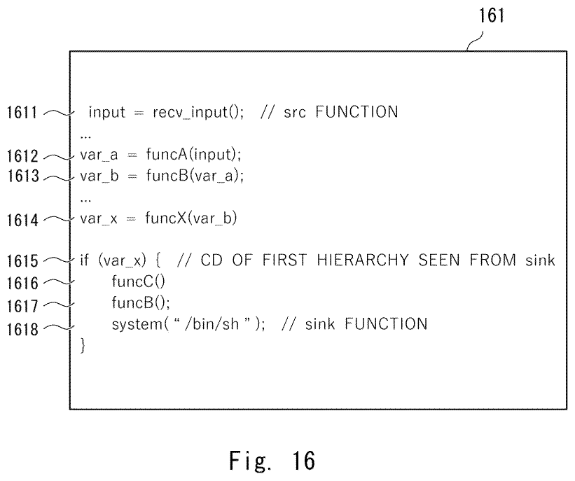

FIG. 16 is a diagram illustrating a sample code 161 for explaining a third calculation method. The sample code 161 has codes 1611 to 1618. In the processing flow to be analyzed illustrated in the figure, the start point is the external input (src function) indicated in a code 1611. The end point is a system function (sink function) indicated by a code 1618. In addition, a code having a control dependency on the code 1618 and located at a position closest to the code is a code 1615 indicating conditional branching.

The score calculation unit 14 calculates the backdoor score according to the number of function nodes to the sink function from the control dependency located in the first hierarchy with respect to the sink function. Therefore, the score calculation unit 14 calculates the backdoor score based on the number of function nodes between the code 1615 and the code 1618.

As the number of function nodes passed through increases, the distance from the point indicating the control dependency to the n-th hierarchy to the sink function increases. Therefore, it is assumed that the attacker is less likely to trigger the sensitive function.

In this calculation method, in a case where x is the number of function nodes, the backdoor score fb (x) is expressed by the following Formula (2).

$$fb ( x ) = 1 / x \qquad ( 2 )$$

In the example of the figure, two function calling locations exist from the point indicating the control dependency of the target to the sink function. Including the sink function calling itself, three function nodes exist. Therefore, the score calculation unit 14 calculates the backdoor score as ⅓.

In this way, the score calculation unit 14 can calculate the backdoor score according to the number of function nodes existing from the point indicating the control dependency up to the n-th hierarchy to the sink function.

### (Fourth Calculation Method)

The score calculation unit 14 may calculate the backdoor score based on the number of nodes on the function flow passed through between a first code indicating a sensitive operation and a second code having a control dependency with respect to the first code and located at a position closest to the first code.

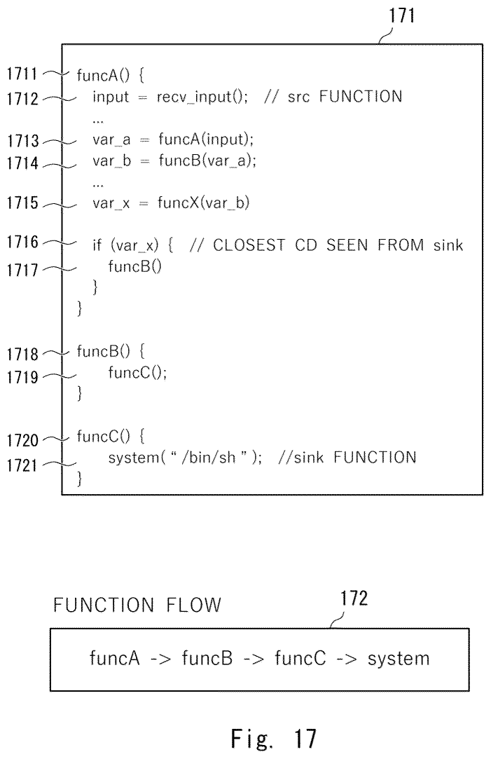

FIG. 17 is a diagram illustrating a sample code 171 for explaining a fourth calculation method. The sample code 171 has codes 1711 to 1721. In addition, a function flow 172 corresponding to the sample code 171 is illustrated together with the sample code 171.

In this calculation method, the score calculation unit 14 calculates the backdoor score according to the number of nodes on the functional flow passed through from the code having a control dependency of one hierarchy with respect to the sink function to the sink function calling.

It is assumed that, as the number of function nodes passed through increases, the distance from the point indicating the control dependency to the n-th hierarchy to the sink function increases, and triggering is less likely to occur.

In this calculation method, in a case where the number of nodes on the function flow passed through is x, the backdoor score fc (x) is expressed by the following Formula (3).

$$fc ( x ) = 1 / x \qquad ( 3 )$$

In the example of the figure, a process is performed from a code 1716 which is a point indicating a control dependency with a code 1721 which is a sink function to the code 1721 through funcB and funcC on the function flow. Therefore, including the sink function calling itself, there are three function nodes passed through. Therefore, the score calculation unit 14 calculates the backdoor score as ⅓.

Returning to FIG. 7, the description will be continued. The output unit 15 outputs the backdoor score calculated by the score calculation unit 14. The output unit 15 may output the relationship information acquired by the analyzing unit 11 or the construction information generated by the construction information generation unit 12. The output unit 15 is, for example, a display device such as a display device. The output unit 15 may output an analysis result or the like in another mode. For example, the output unit 15 may output information to an information terminal used by the user via a network (not illustrated).

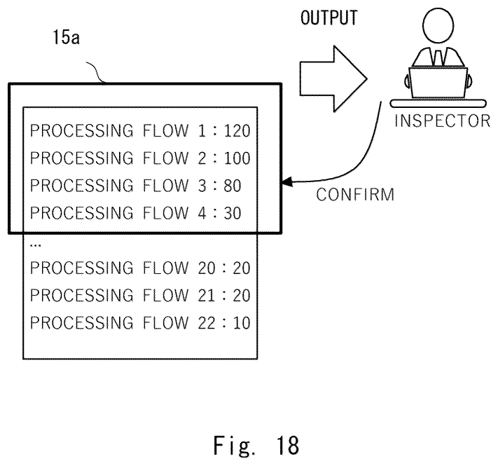

FIG. 18 is a diagram illustrating an output example 15a of the backdoor score. For example, the output unit 15 notifies the inspector of only a processing flow in which a score of a certain value or greater is calculated. The inspector can efficiently perform the inspection by confirming the notified processing flow.

Returning to FIG. 7, the description will be continued. The storage unit 19 stores the scoring policy 191. In addition, the storage unit 19 can store a computer program (not illustrated) in which the process of the program analysis method according to the present example embodiment is implemented.

The configuration of the program analysis device 10 has been described above. The configuration of the program analysis device 10 described above is merely an example, and can be appropriately changed. For example, in a case where some or all the configuring elements of the program analysis device 10 are achieved by a plurality of information processing devices, circuits, and the like, the plurality of information processing devices, circuits, and the like may be arranged in a centralized manner or in a distributed manner. For example, the information processing devices, the circuits, or the like may be implemented in the form of a client server system, a cloud computing system, or the like in which they are connected to each other through a communication network. Furthermore, the function of the program analysis device 10 may be provided in a software as a service (SaaS) format.

Furthermore, in the above description, it is assumed that the program to be analyzed is in a binary format and a binary of the program is input, but a source code may be adopted as an analysis target. In that case, for example, the analyzing unit 11 may input a source code to be analyzed, compile the input source code, and convert the source code into a binary format. Furthermore, the analyzing unit 11, the construction information generation unit 12, the flow length acquisition unit 13, the score calculation unit 14, or a processing unit (not illustrated) may appropriately use information obtained from the source code for analysis.

### (Process of Program Analysis Device 10)

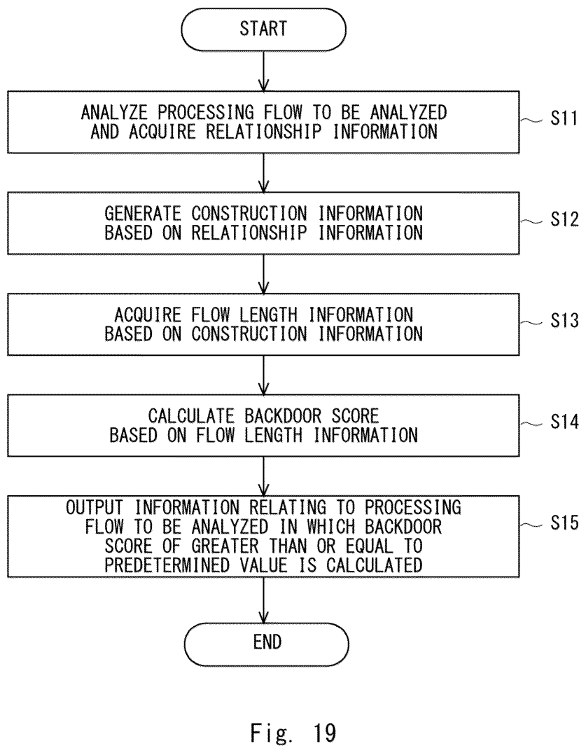

Next, a process performed by the program analysis device 10 according to the present example embodiment will be described with reference to FIG. 19. FIG. 19 is a flowchart illustrating a process performed by the program analysis device 10.

First, the analyzing unit 11 analyzes the processing flow to be analyzed and acquires relationship information (S11). For example, the analyzing unit 11 extracts predetermined start point and end point from the program, specifies the processing flow to be analyzed, and analyzes the processing flow to be analyzed to acquire the relationship information. The relationship information indicates a relationship among a plurality of codes included in the processing flow to be analyzed.

Next, the construction information generation unit 12 generates construction information based on the relationship information (S12). The construction information indicates how the processing flow to be analyzed is constructed. The construction information generation unit 12 may generate construction information using a predetermined model.

Subsequently, the flow length acquisition unit 13 acquires flow length information indicating the length of the processing flow to be analyzed including the sensitive operation based on the construction information (S13). The flow length information may include, for example, information indicating the number of function nodes existing between two codes or information related to the number of hierarchies described above.

Subsequently, the score calculation unit 14 calculates a backdoor score of the processing flow to be analyzed based on the flow length information (S14). For example, the score calculation unit 14 can calculate the backdoor score using any one of the plurality of calculation methods described above. The score calculation unit 14 may calculate the backdoor score by combining a plurality of calculation methods.

Then, the output unit 15 outputs information related to the processing flow to be analyzed in which the backdoor score of equal to or more than a predetermined value is calculated (S15).

As described above, the program analysis device 10 according to the present example embodiment acquires the flow length information indicating the length of the processing flow to be analyzed including the sensitive operation defined by the predetermined start point and the predetermined end point in the program. In addition, the program analysis device 10 can calculate the backdoor score based on the flow length information.

With such a configuration, the program analysis device 10 can automatically detect, for example, a processing flow to be analyzed that triggers execution of a sensitive operation by an external input, and further score the grade of malignancy for each processing flow.

Thus, the program analysis device 10 according to the present example embodiment can appropriately specify a processing flow having a high possibility of including a backdoor from among a plurality of candidate processing flows. In addition, it is possible to set priority to the subsequent confirmation work of the inspection result by the inspector.

### Configuration Example of Hardware

Each functional configuration unit of the program analysis devices 1001 and 10 (hereinafter referred to as the “program analysis device 1001 etc.”) may be achieved by hardware (e.g., a hard-wired electronic circuit etc.) that achieves each functional configuration unit, or may be achieved by a combination of hardware and software (e.g., a combination of an electronic circuit and a program for controlling the same etc.). Hereinafter, a case where each functional configuration unit of the program analysis device 1001 or the like is achieved by a combination of hardware and software will be further described.

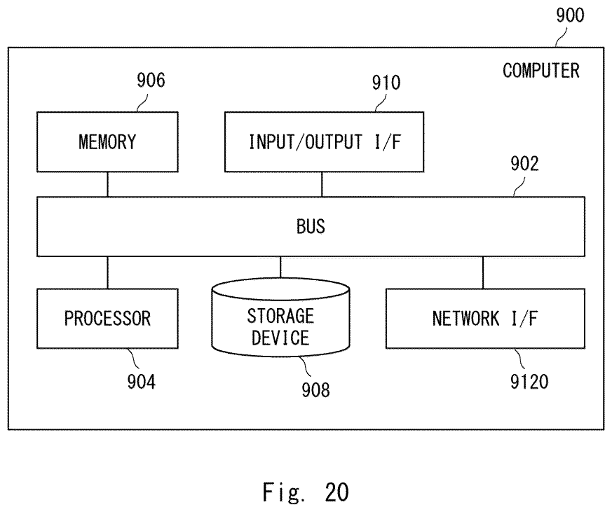

FIG. 20 is a block diagram illustrating a hardware configuration of a computer 900 that achieves the program analysis device 1001 and the like. The computer 900 may be a dedicated computer designed to achieve the program analysis device 1001 and the like, or may be a general-purpose computer. The computer 900 may be a portable computer such as a smartphone or a tablet terminal.

For example, each function of the program analysis device 1001 and the like is achieved on the computer 900 by installing a predetermined application to the computer 900. The above application is configured by a program for achieving a functional configuration unit of the program analysis device 1001 and the like.

The computer 900 includes a bus 902, a processor 904, a memory 906, a storage device 908, an input/output interface 910, and a network interface 9120. The bus 902 is a data transmission path for the processor 904, the memory 906, the storage device 908, the input/output interface 910, and the network interface 9120 to transmit and receive data to and from each other. However, a method for connecting the processor 904 and the like to each other is not limited to the bus connection.

The processor 904 is various processors such as a central processing unit (CPU), a graphics processing unit (GPU), a field-programmable gate array (FPGA), and a quantum processor (quantum computer control chip). The memory 906 is a main storage device achieved with use of a random access memory (RAM) or the like. The storage device 908 is an auxiliary storage device achieved by using a hard disk, a solid state drive (SSD), a memory card, read only memory (ROM), or the like.

The input/output interface 910 is an interface for connecting the computer 900 with an input/output device. For example, an input device such as a keyboard and an output device such as a display device are connected with the input/output interface 910.

The network interface 9120 is an interface connecting the computer 900 to a network. The network may be a local area network (LAN) or a wide area network (WAN).

The storage device 908 stores a program for achieving each functional configuration unit of the program analysis device 1001 and the like (a program for achieving the application mentioned above). The processor 904 reads such a program into the memory 906, and executes the program to implement each functional configuration unit of the program analysis device 1001 and the like.

Each of the processors executes one or more programs including an instruction group for causing a computer to perform the algorithm that has been described with reference to the drawings. The program includes an instruction group (or software codes) for causing the computer to perform one or more functions that have been described in the example embodiments in a case where the program is read by the computer. The program may be stored in various types of a non-transitory computer readable medium or a tangible storage medium. Without being limited, but examples of the non-transitory computer readable medium or the tangible storage medium include a random-access memory (RAM), a read-only memory (ROM), a flash memory, a solid-state drive (SSD) or any other memory technology, a CD-ROM, a digital versatile disc (DVD), a Blu-ray (registered trademark) disk or any other optical disk storage, a magnetic cassette, a magnetic tape, a magnetic disk storage, or any other magnetic storage device. The program may also be transmitted in various types of the transitory computer readable medium or a communication medium. Without being limited, but examples of the transitory computer readable medium or the communication medium include an electric signal, an optical signal, an acoustic signal, or any other form of propagation signal.

The present disclosure is not limited to the above example embodiments, and can be appropriately changed without departing from the gist. The above-described example embodiments can be executed in any combination.

Some or all the above-described example embodiments may be described as the following Supplementary Notes, but are not limited to the following Supplementary Notes.

### Supplementary Note 1

A program analysis device including:
flow length acquisition means for acquiring flow length information indicating a length of a processing flow to be analyzed including a sensitive operation defined by a predetermined start point and a predetermined end point in a program; and
score calculation means for calculating a backdoor score indicating a possibility that the processing flow to be analyzed is a backdoor code based on the flow length information.

### Supplementary Note 2

The program analysis device according to supplementary note 1, further including construction information generation means for acquiring relationship information indicating a relationship among a plurality of codes included in the processing flow to be analyzed and generating construction information indicating how the processing flow to be analyzed is constructed based on the relationship information,
in which the flow length acquisition means acquires the flow length information based on the construction information.

### Supplementary Note 3

The program analysis device according to supplementary note 2, further including analyzing means for specifying the processing flow to be analyzed by extracting the predetermined start point and end point from the program, and acquiring the relationship information by performing an analysis on the processing flow to be analyzed,
in which the construction information generation means generates the construction information based on the relationship information acquired by the analyzing means.

### Supplementary Note 4

The program analysis device according to supplementary note 3, in which the analyzing means acquires the relationship information by performing, as the analysis, at least one of a control flow analysis for obtaining control flow information indicating a control dependency among the plurality of codes and a data flow analysis for obtaining data flow information indicating a data dependency among the plurality of codes.

### Supplementary Note 5

The program analysis device according to supplementary note 1 or 2, in which the score calculation means calculates the backdoor score according to a feature amount of the processing flow to be analyzed including number of hierarchies indicated by a control dependency included in the processing flow to be analyzed.

### Supplementary Note 6

The program analysis device according to supplementary note 5, in which the score calculation means calculates the backdoor score such that in a case where the number of hierarchies is equal to or less than n (n is a natural number equal to or more than two), the backdoor score is higher than in a case where the number of hierarchies is larger than n.

### Supplementary Note 7

The program analysis device according to supplementary note 5 or 6, in which the score calculation means calculates the backdoor score such that the backdoor score increases as the number of hierarchies decreases.

### Supplementary Note 8

The program analysis device according to any one of supplementary notes 5 to 7, in which
the flow length information includes number of function nodes among a plurality of codes included in the processing flow to be analyzed, and
the score calculation means calculates the backdoor score based on the number of function nodes between a first code indicating an external input and a second code indicating a control dependency of a first hierarchy from the first code.

### Supplementary Note 9

The program analysis device according to any one of supplementary notes 5 to 8, in which
the flow length information includes number of function nodes among a plurality of codes included in the processing flow to be analyzed, and
the score calculation means calculates the backdoor score based on the number of function nodes between a first code indicating a sensitive operation and a second code having a control dependency with respect to the first code and located at a position closest to the first code.

### Supplementary Note 10

The program analysis device according to any one of supplementary notes 5 to 9, in which
the flow length information includes number of function nodes among a plurality of codes included in the processing flow to be analyzed, and
the score calculation means calculates the backdoor score based on the number of nodes on a function flow passed through between a first code indicating a sensitive operation and a second code having a control dependency with respect to the first code and located at a position closest to the first code.

### Supplementary Note 11

The program analysis device according to any one of supplementary notes 1 to 10, in which the start point is a function for acquiring an external input, and
the end point is a function that can perform a sensitive operation on a system including the program in a case where it is illegally executed.

### Supplementary Note 12

A program analysis method including:
acquiring flow length information indicating a length of a processing flow to be analyzed including a sensitive operation defined by a predetermined start point and a predetermined end point in a program, and
calculating a backdoor score indicating a possibility that the processing flow to be analyzed is a backdoor code based on the flow length information.

### Supplementary Note 13

The program analysis method according to supplementary note 12, further including acquiring relationship information indicating a relationship among a plurality of codes included in the processing flow to be analyzed and generating construction information indicating how the processing flow to be analyzed is constructed based on the relationship information,
in which the acquiring of the flow length information includes acquiring the flow length information based on the construction information.

### Supplementary Note 14

A non-transitory computer readable medium stored with a program for causing a computer to execute processes of:
acquiring flow length information indicating a length of a processing flow to be analyzed including a sensitive operation defined by a predetermined start point and a predetermined end point in a program, and
calculating a backdoor score indicating a possibility that the processing flow to be analyzed is a backdoor code based on the flow length information.

### Supplementary Note 15

The non-transitory computer readable medium according to supplementary note 14, further causing the computer to execute the process of:
acquiring relationship information indicating a relationship among a plurality of codes included in the processing flow to be analyzed and generating construction information indicating how the processing flow to be analyzed is constructed based on the relationship information,
in which the process of acquiring the flow length information includes acquiring the flow length information based on the construction information.

### REFERENCE SIGNS LIST

10, 1001 program analysis device
11 analyzing unit
12 construction information generation unit
13, 1003 flow length acquisition unit
14, 1004 score calculation unit
15 output unit
19 storage unit
52 model
53 report
51, 61, 91, 101, 111, 121, 131, 151, 161, 171 sample code
81, 82 code block
172 function flow
191 scoring policy
A1 to A6 node
B1 to B6 node
C1 to C5 node
CF1 to CF3 control flow
CD control dependency
DD data dependency
EI external input
P1 entry point
T1 conditional branch
900 computer
904 processor
906 memory
908 storage device
910 input/output interface
9120 network interface

What is claimed is:

1. A program analysis device comprising:
at least one memory storing instructions; and
at least one processor configured to execute the instructions to:
acquire flow length information indicating a length of a processing flow to be analyzed including a sensitive operation defined by a predetermined start point and a predetermined end point in a program; and
calculate a backdoor score indicating a possibility that the processing flow to be analyzed is a backdoor code based on the flow length information.

2. The program analysis device according to claim 1, wherein the at least one processor is further configured to execute the instructions to acquire relationship information indicating a relationship among a plurality of codes included in the processing flow to be analyzed and generate construction information indicating how the processing flow to be analyzed is constructed based on the relationship information, and
acquire the flow length information based on the construction information.

3. The program analysis device according to claim 2, wherein the at least one processor is further configured to execute the instructions to specify the processing flow to be analyzed by extracting the predetermined start point and end point from the program and acquire the relationship information by performing an analysis on the processing flow to be analyzed, and
generate the construction information based on the acquired relationship information.

4. The program analysis device according to claim 3, wherein the at least one processor is further configured to execute the instructions to acquire the relationship information by performing, as the analysis, at least one of a control flow analysis for obtaining control flow information indicating a control dependency among the plurality of codes and a data flow analysis for obtaining data flow information indicating a data dependency among the plurality of codes.

5. The program analysis device according to claim 1, wherein the at least one processor is further configured to execute the instructions to calculate the backdoor score according to a feature amount of the processing flow to be analyzed including number of hierarchies indicated by a control dependency included in the processing flow to be analyzed.

6. The program analysis device according to claim 5, wherein the at least one processor is further configured to execute the instructions to calculate the backdoor score such that in a case where the number of hierarchies is equal to or less than n (n is a natural number equal to or more than two), the backdoor score is higher than in a case where the number of hierarchies is larger than n.

7. The program analysis device according to claim 5, wherein the at least one processor is further configured to execute the instructions to calculate the backdoor score such that the backdoor score increases as the number of hierarchies decreases.

8. The program analysis device according to claim 5, wherein
the flow length information includes number of function nodes among a plurality of codes included in the processing flow to be analyzed, and
the at least one processor is further configured to execute the instructions to calculate the backdoor score based on the number of function nodes between a first code indicating an external input and a second code indicating a control dependency of a first hierarchy from the first code.

9. The program analysis device according to claim 5, wherein
the flow length information includes number of function nodes among a plurality of codes included in the processing flow to be analyzed, and
the at least one processor is further configured to execute the instructions to calculate the backdoor score based on the number of function nodes between a first code indicating a sensitive operation and a second code having a control dependency with respect to the first code and located at a position closest to the first code.

10. The program analysis device according to claim 5, wherein
the flow length information includes number of function nodes among a plurality of codes included in the processing flow to be analyzed, and
the at least one processor is further configured to execute the instructions to calculate the backdoor score based on the number of nodes on a function flow passed through between a first code indicating a sensitive operation and a second code having a control dependency with respect to the first code and located at a position closest to the first code.

11. The program analysis device according to claim 1, wherein the start point is a function for acquiring an external input, and the end point is a function that can perform a sensitive operation on a system including the program in a case where it is illegally executed.

12. A program analysis method comprising:
acquiring flow length information indicating a length of a processing flow to be analyzed including a sensitive operation defined by a predetermined start point and a predetermined end point in a program; and
calculating a backdoor score indicating a possibility that the processing flow to be analyzed is a backdoor code based on the flow length information.

13. The program analysis method according to claim 12, further comprising acquiring relationship information indicating a relationship among a plurality of codes included in the processing flow to be analyzed and generating construction information indicating how the processing flow to be analyzed is constructed based on the relationship information,
wherein the acquiring of the flow length information includes acquiring the flow length information based on the construction information.

14. A non-transitory computer readable medium stored with a program for causing a computer to execute processes of:
acquiring flow length information indicating a length of a processing flow to be analyzed including a sensitive operation defined by a predetermined start point and a predetermined end point in a program; and
calculating a backdoor score indicating a possibility that the processing flow to be analyzed is a backdoor code based on the flow length information.

15. The non-transitory computer readable medium according to claim 14, further causing the computer to execute the process of acquiring relationship information indicating a relationship among a plurality of codes included in the processing flow to be analyzed and generating construction information indicating how the processing flow to be analyzed is constructed based on the relationship information,
wherein the process of acquiring the flow length information includes acquiring the flow length information based on the construction information.
